(19) United States
(12) Patent Application Publication
(10) Pub. No.: US 2022/0009580 A1
(43) Pub. Date: Jan. 13, 2022

(54) BICYCLE U-LOCK HOLDER

(71) Applicant: Walley Leather Inc., Toronto (CA)

(72) Inventor: Daniel AZIN, Toronto (CA)

(73) Assignee: Walley Leather Inc., Toronto (CA)

(21) Appl. No.: 17/369,673

(22) Filed: Jul. 7, 2021

Related U.S. Application Data
(60) Provisional application No. 63/049,346, filed on Jul. 8, 2020.

(51) Int. Cl. B62J 11/00

(52) U.S. Cl. CPC B62J 11/00

(57) ABSTRACT

A bicycle U-lock holder comprises a main body, one end of the main body defining a foldable first portion that, when folded, defines a first loop dimensioned to circumscribe a first portion of a bicycle frame; at least one strap extending from the main body, the at least one strap extending horizontally with respect to the main body and dimensioned to receive a U-lock; and a removable strap having a first end connected to the main body and extending therefrom, the removable strap defining a second loop dimensioned to circumscribe a second portion of the bicycle frame.

### CROSS-REFERENCE TO RELATED APPLICATIONS

This application claims priority to U.S. Provisional No. 63/049,346 entitled “ADJUSTABLE U-LOCK HOLSTER ATTACHABLE WITHIN A BICYCLE FRAME”, filed on Jul. 8, 2020, the entire contents of which are incorporated herein by reference.

### TECHNICAL FIELD

The present application relates to bicycle lock holders and in particular to a bicycle U-lock holder.

### BACKGROUND

Bicycle U-lock holders are used to secure a U-lock to a bicycle.

Many bicycle U-lock holders are designed to secure only a single size U-lock to the bicycle. Further, many bicycle U-lock holders are designed to secure the U-lock to only a particular type of bicycle.

### BRIEF DESCRIPTION OF THE DRAWINGS

Embodiments are described in detail below, with reference to the following drawings:

FIG. 1 is a front view of a bicycle U-lock holder;

FIG. 2 is a front view of the bicycle U-lock holder of FIG. 1 in an open and unconnected state;

FIG. 3 is a side view of the bicycle U-lock holder of FIG. 1;

FIG. 4 is an exploded view of a connector;

FIG. 5 is a side view of a diamond-frame bicycle;

FIG. 6 is an enlarged view showing the bicycle U-lock holder of FIG. 1 connected to a portion of the bicycle of FIG. 5;

FIG. 7 is another enlarged view showing the bicycle U-lock holder of FIG. 1 connected to a portion of the bicycle of FIG. 5 and holding a U-lock;

FIG. 8 is an isometric view showing the bicycle U-lock holder of FIG. 1 connected to a portion of the bicycle of FIG. 5;

FIG. 9 is an isometric view showing the bicycle U-lock holder of FIG. 1 connected to another portion of the bicycle of FIG. 5;

FIG. 10 is a side view of a step-through bicycle;

FIG. 11 is an enlarged view showing the bicycle U-lock holder of FIG. 1 connected to a portion of the bicycle of FIG. 10 and holding a U-lock;

FIG. 12 is an isometric view showing the bicycle U-lock holder of FIG. 1 connected to a portion of the bicycle of FIG. 10; and

FIG. 13 is a back view of a bicycle U-lock holder.

Like reference numerals are used in the drawings to denote like elements and features.

### DETAILED DESCRIPTION OF VARIOUS EMBODIMENTS

Accordingly, in on aspect there is provided a bicycle U-lock holder comprising a main body, one end of the main body defining a foldable first portion that, when folded, defines a first loop dimensioned to circumscribe a first portion of a bicycle frame; at least one strap extending from the main body, the at least one strap extending horizontally with respect to the main body and dimensioned to receive a U-lock; and a removable strap having a first end connected to the main body and extending therefrom, the removable strap defining a second loop dimensioned to circumscribe a second portion of the bicycle frame.

In one or more embodiments, the removable strap connects to one of a plurality of openings defined in an opposite end of the main body via a first connector, the plurality of openings dimensioned to receive the first connector.

In one or more embodiments, the first connector includes a sex bolt.

In one or more embodiments, the plurality of openings is three spaced-apart openings defined in the opposite end of the main body.

In one or more embodiments, the removable strap includes a plurality of spaced apart openings dimensioned to receive the first connector or a second connector.

In one or more embodiments, the second connector includes a sex bolt.

In one or more embodiments, the first connector extends through one of the openings on the removable strap and one of the openings defined in the opposite end of the main body.

In one or more embodiments, the second connector extends through one of the openings on the removable strap and another one of the openings on the removable strap thereby defining the second loop.

In one or more embodiments, the at least one strap extending from the main body is adjustable to accommodate different sizes of the U-lock.

In one or more embodiments, the at least one strap includes a first portion extending from a side of the main body, a second middle portion connected to the main body, and a third portion extending from an opposite side of the main body.

In one or more embodiments, one of the first portion and the third portion includes a connector and the other of the first portion and the third portion includes a plurality of openings dimensioned to receive and retain the connector.

In one or more embodiments, inserting the connector through a first one of the plurality of openings accommodates a first size of U-lock and inserting the connector through a second one of the plurality of openings accommodates a second size of U-lock.

In one or more embodiments, one of the first portion and the third portion includes a single opening dimensioned to receive a connector and the other of the first portion and the third portion includes a plurality of openings dimensioned to receive the connector, the connector inserted through the single opening and one of the plurality of openings.

In one or more embodiments, the at least one strap extending from the main body is integral with the main body and includes a first portion extending from a side of the main body and a second portion extending from an opposite side of the main body.

In one or more embodiments, the at least one strap extending from the main body includes a pair of spaced apart straps.

In one or more embodiments, the foldable first portion includes a first plurality of openings dimensioned to receive a connector and main body includes a second plurality of openings dimensioned to receive the connector, the connector extending through one of the first plurality of openings and through one of the second plurality of openings thereby defining the first loop.

In one or more embodiments, the connector includes a sex bolt.

In one or more embodiments, inserting the connector through a first one of the first plurality of openings and through a first one of the second plurality of openings defines a first size of the first loop and inserting the connector through a second one of the first plurality of openings and through a second one of the second plurality of openings defines a second size of the first loop.

In one or more embodiments, the main body is generally rectangular.

In one or more embodiments, the main body is made of leather or rubber.

In one or more embodiments, a back side of the main body includes a pocket.

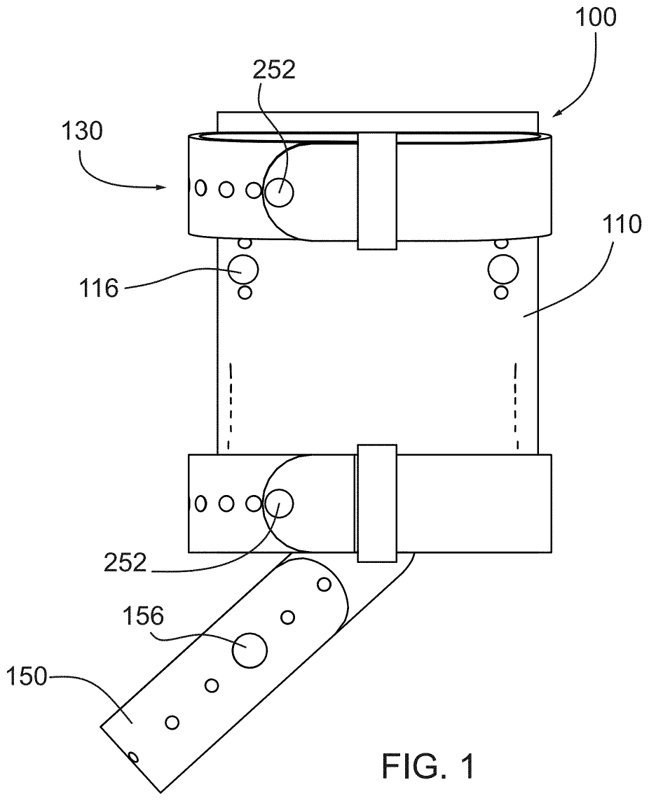

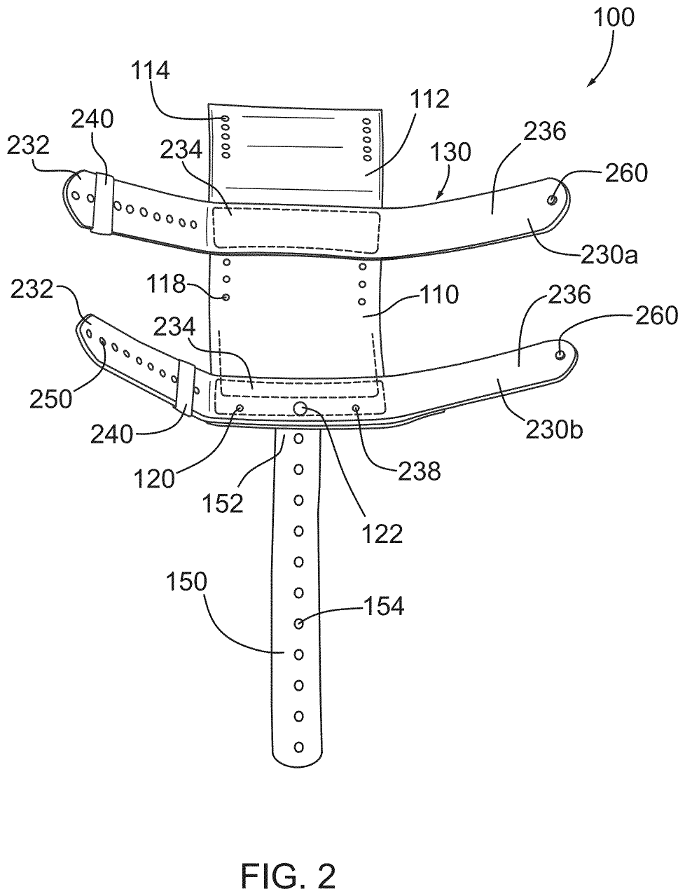

Turning to FIGS. 1 and 2, a bicycle U-lock holder is shown and is generally identified by reference numeral 100. The bicycle U-lock holder 100 comprises a main body 110, at least one strap 130 extending from the main body 110, and a removable strap 150 having a first end 152 connected to the main body 110 and extending therefrom. The main body 110, the strap 130 and the removable strap 150 may be made of a material that is stiff and rigid such as for example leather or rubber.

As will be described in more detail, the bicycle U-lock holder 100 is adjustable to accommodate different sizes and shapes of bicycles and different sizes of U-locks. Once installed, the bicycle U-lock holder is able to secure a U-lock to a bicycle while reducing rattling and/or shaking of the U-lock while the bicycle is being used.

The bicycle U-lock holder 100 is shown in FIG. 2 in an open and unconnected state. As can be seen, a first end of the main body 110 defines a foldable first portion 112. The foldable first portion 112 includes a first plurality of openings 114 dimensioned to receive a connector 116 (shown in FIG. 1). In this embodiment, the first plurality of openings 114 includes five (5) pairs of openings positioned on opposing sides of the foldable first portion 112.

In addition to the first plurality of openings 114 located on the foldable first portion 112, the main body 110 includes a second plurality of openings 118 dimensioned to receive the connector 116 (shown in FIG. 1). In this embodiment, the second plurality of openings 118 includes three (3) pairs of openings positioned on opposing sides of the main body 110 at a location below the at least one strap 130.

The main body 110 includes a third plurality of openings 120 defined in a second end thereof. The second end of the main body 110 is opposite the first end of the main body 110. In this embodiment, the third plurality of openings 120 includes three (3) spaced apart openings each of which is dimensioned to receive a connector 122.

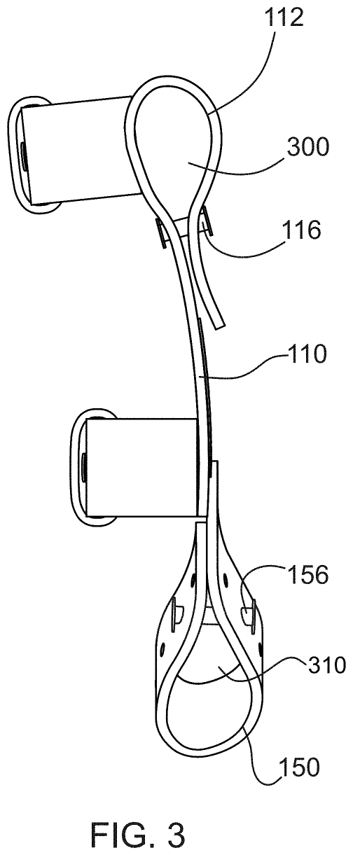

As shown in FIG. 3, the foldable first portion 112 is foldable to define a first loop 300 dimensioned to circumscribe a first portion of a bicycle frame (not shown). The first portion of the bicycle frame may include a tube of the bicycle frame such as the top tube of the bicycle frame. In this embodiment, the foldable first portion 112 is folded such that that foldable first portion 112 contacts a back side of the main body 110 and one or more of the first plurality of openings 114 aligns with one or more of the second plurality of openings 118 and connectors 116 are inserted therethrough. In this manner, the foldable first portion 112 defines the first loop 300. As will be described in more detail below, by inserting the connectors 116 through different ones of the openings 114 and/or openings 118, the size of the first loop 300 is adjusted to accommodate different sizes and shapes of bicycle frames. Put another way, the size of the first loop 300 is adjusted to change the length between a given tube of a bicycle and the bicycle U-lock holder 100 and as such the bicycle U-lock holder 100 is adjustable to accommodate different sizes and shapes of bicycle frames.

Referring back to FIG. 2, the at least one strap 130 extending from the main body 110 is adjustable to accommodate different sizes of U-locks. In this embodiment, the at least one strap 130 includes a pair of spaced apart straps 230a, 230b, each of which is connected to a front of the main body 110 such that it is fixed in position with respect to the main body 110. Specifically, each strap 230a, 230b includes a first portion 232 extending from a side of the main body 110, a second middle portion 234 connected to the main body 110, and a third portion 236 extending from an opposite side of the main body 110. In this embodiment, the second middle portion 234 is connected to the main body 110 via stitching. A loop 240 is positioned on each strap 230a, 230b and may be used to secure the strap 230a, 230b, similar to that of a belt.

As shown in FIG. 2, the second middle portion 234 of strap 230b includes a plurality of openings 238. In this embodiment, the plurality of openings 238 includes three (3) spaced apart openings. The plurality of openings 238 are aligned with the third plurality of openings 120 defined in the main body 110. The plurality of openings 238 are dimensioned to receive the connector 122.

In this embodiment, the first portion 232 of each strap 230a, 230b includes a plurality of openings 250 dimensioned to receive a connector 252 (shown in FIG. 1) and the third portion 236 of each strap 230a, 230b includes a single opening 260 dimensioned to receive the connector 252 (shown in FIG. 1). It will be appreciated that in another embodiment the first portion 232 of each strap 230a, 230b may include the single opening and the third portion 236 of each strap 230a, 230b may include the plurality of openings. As will be described in more detail below, the connector 252 is insertable through the single opening 260 and through one of the plurality of openings 250. By inserting the connector 252 through different ones of the plurality of openings 250, the straps 230a, 230b are adjusted to accommodate a particular size of U-lock. Put another way, by changing which one of the plurality of openings 250 the connector 252 is inserted through, the straps 230a, 230b are adjusted to accommodate different sizes of U-locks.

The removable strap 150 has a first end 152 connected to the main body 110 and extending therefrom. In this embodiment, the removable strap 150 includes a plurality of spaced apart openings 154 dimensioned to receive connector 122 or a connector 156 (shown in FIG. 1). The plurality of spaced apart openings 154 are generally equally spaced throughout a length of the removable strap 150.

The removable strap 150 connects to the main body 110 via the connector 122. In this embodiment, the removable strap 150 may be connected to the main body at one (1) of three (3) positions, where each position is defined by one of the three plurality of openings 120 of the main body 110, which in this embodiment are aligned with the openings 238 on the strap 230b. To connect the removable strap 150, the removable strap 150 is positioned such that one of the openings 154 is aligned with one of the openings 238 on strap 230b which is aligned with one of the third plurality of openings 120 defined in the second end of the main body 110. The connector 122 is inserted through the aligned openings and as such the removable strap 150 is connected to the main body 110. In this manner, the removable strap 150 is connectable to the main body 110 in different positions. Put another way, by positioning one of the openings 154 in alignment with one of the openings 238 on the strap 230b which is aligned with one of the third plurality of openings 120 defined in the second end of the main body 110, the position of the removable strap 150 is adjustable to accommodate different sizes and shapes of bicycle frames. Prior to inserting the connector 122 through the openings and/or prior to tightening the connector 122, the removable strap 150 may be positioned with respect to the main body 110 such that it may extend from the main body 110 in a particular direction and this may be adjusted to accommodate different sizes and shapes of bicycle frames.

As shown in FIG. 3, the removable strap 150 defines a second loop 310 dimensioned to circumscribe a second portion of a bicycle frame (not shown). The second portion of the bicycle frame may include a tube of the bicycle frame. It will be appreciated that the first portion and the second portion of the bicycle frame are different portions of the bicycle frame and may be different tubes of the bicycle frame. For example, the first portion of the bicycle frame may include the top tube of a diamond-frame bicycle and the second portion of the bicycle frame may include the seat tube or the down tube of the diamond-frame bicycle.

In this embodiment, the removable strap 150 is folded such that one of the openings 154 is aligned with another one of the openings 154 thereby defining the second loop. The connector 156 is inserted through the aligned openings. As will be described in more detail below, by inserting the connector 156 through different aligned openings 154, the size of the second loop 310 is adjusted to accommodate different sizes and shapes of bicycle frames.

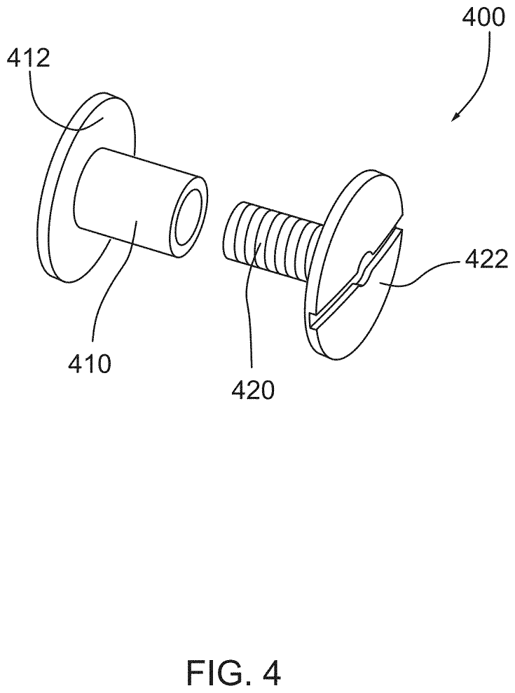

An example connector 400 in the form of a sex bolt is shown in FIG. 4. The term sex bolt may also be referred to or commonly known as a barrel nut and/or a barrel bolt, a binding barrel, a Chicago screw, a post and screw or a connector bolt. The connector 400 includes a female internally threaded barrel 410 and a male externally threaded screw 420. A threaded connection is formed when the screw 420 is inserted into the barrel 410 and rotated. Heads 412, 422 of the barrel 410 and the screw 420, respectively, clamp or otherwise bind material when the connector 400 is tightened. The connectors 116, 122, 156, 252 described herein may be of the same type as connector 400. It will be appreciated that connectors 116, 122, 156 and 252 may be the same size or may be different sizes.

Although the connectors described herein may be of the type of connector 400, it will be appreciated that other types of connectors may be used. For example, a connector that includes a wing-nut and a bolt may be used. As another example, a belt-like connector may be used that includes a buckle and a prong.

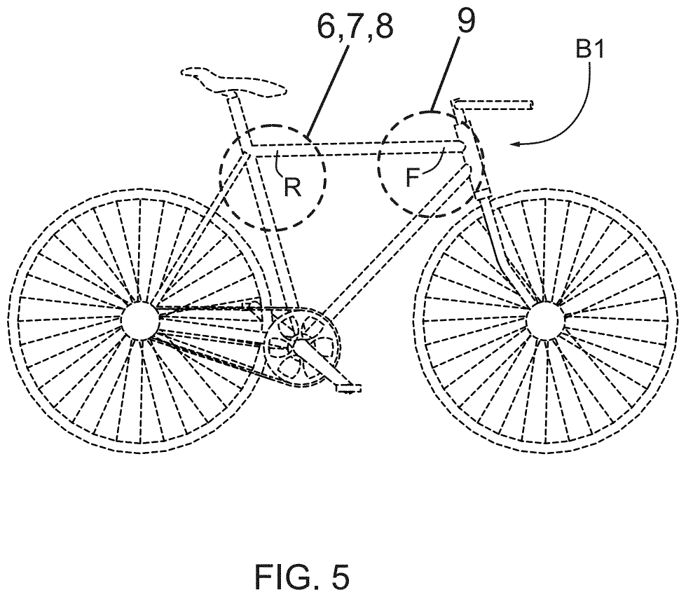

During use, the bicycle U-lock holder 100 is installed on a bicycle. An example bicycle B1 is shown in FIG. 5. The example bicycle B1 is a diamond-frame bicycle. The bicycle U-lock holder 100 may be connected to the rear of the bicycle B1 such as at position R shown in FIG. 5 or may be connected to the front of the bicycle B1 such as at position F shown in FIG. 5.

Prior to installation on a bicycle, the bicycle U-lock holder 100 may be in an open and unconnected state as shown in FIG. 2. During installation, the bicycle U-lock holder 100 is positioned adjacent to a desired location on the bicycle. The foldable first portion 112 is folded around a first portion of the bicycle frame such that the defined first loop circumscribes the first portion of the bicycle frame. One pair of the first plurality of openings 114 of the main body 110 is aligned with one pair of the second plurality of openings 118 and the connectors 116 are inserted therethrough. The connectors 116 are tightened.

The removable strap 150 may be removed from the main body 110 to select which one of the three positions the removable strap 150 is to be connected to. One of the openings 154 is aligned with one of the third plurality of openings 120 defined in the second end of the main body 110 (and in this embodiment with one of the openings 238 on strap 230b). The connector 122 is inserted through the aligned openings to connect the removable strap 150 to the main body 110. Prior to fully tightening the connector 122, the position of the removable strap 150 may be adjusted such that the removable strap 150 extends towards a second portion of the bicycle frame. In this manner, the removable strap 150 may be adjusted based on the length between the second portion of the bicycle frame and the bicycle U-lock holder 100.

The removable strap 150 is folded around the second portion of the bicycle frame such that the defined second loop circumscribes the second portion of the bicycle frame. One of the openings 154 is aligned with another one of the openings 154 and the connector 156 is inserted through the aligned openings. The connector 156 is tightened. The bicycle U-lock holder 100 is connected to the bicycle.

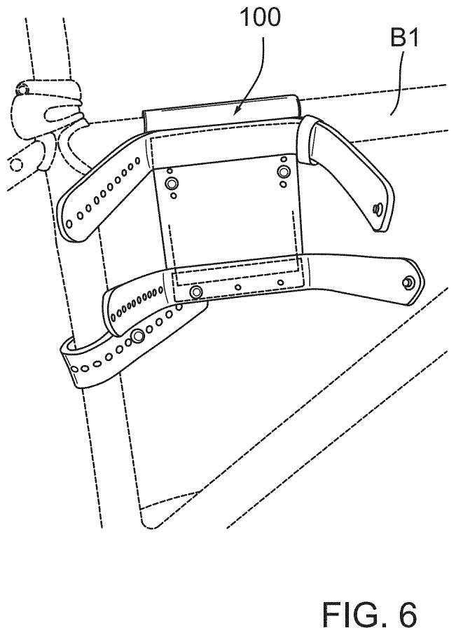

The bicycle U-lock holder 100 is shown connected to the rear of the frame of the bicycle B1 in FIG. 6.

The bicycle U-lock holder 100 is adjustable to accommodate different sizes of U-locks. During installation, the straps 230a, 230b may be opened such that the first portion 232 extends from the side of the main body 110 and the third portion 236 extends from the opposite side of the main body 110. The U-lock is positioned between the first portion 232 and the third portion 236 of the straps 230. The straps are folded around the U-lock and one of the openings 250 on the first portion 232 is aligned with the single opening on the third portion 236 such that the U-lock is secured or otherwise held by the straps 230a, 230b. The connector 252 is inserted through the aligned openings and tightened. It will be appreciated that during installation, the straps 230a, 230b may be folded and secured via connectors 252 prior to inserting the U-lock therein. In this scenario, adjustments may be made to the straps 230a, 230b to ensure the U-lock is held in place thereby. Through use of the rigid material and by adjusting the bicycle U-lock holder 100 to accommodate the size and shape of bicycle and the size of the U-lock, the bicycle U-lock holder 100 is able to secure the U-lock to the bicycle while reducing rattling and/or shaking of the U-lock while the bicycle is being used.

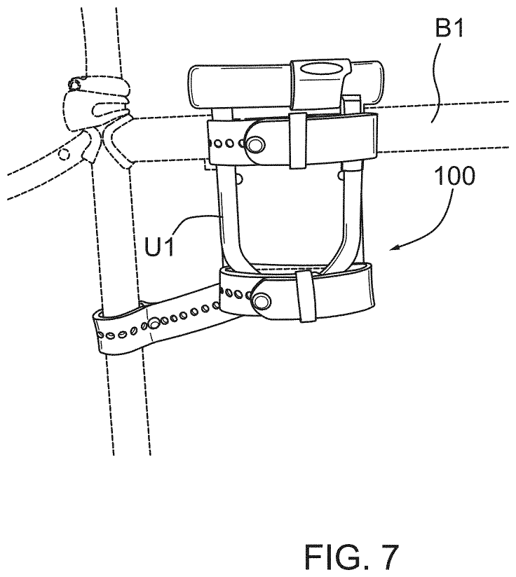

The bicycle U-lock holder 100 is shown connected to the frame of the bicycle B1 and holding a U-lock U1 in FIG. 7.

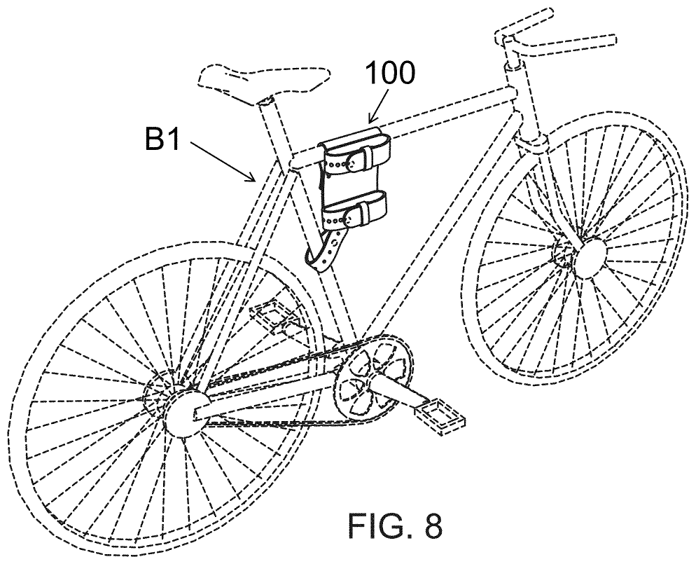

Once installed to accommodate the size and shape of the bicycle and the size of the U-lock, the U-lock may be inserted into and removed from the bicycle U-lock holder 100 without further adjustment. For example, as shown in FIG. 8, the U-lock may be removed from the bicycle U-lock holder 100 while the bicycle U-lock holder 100 maintains its shape and position on the bicycle B1.

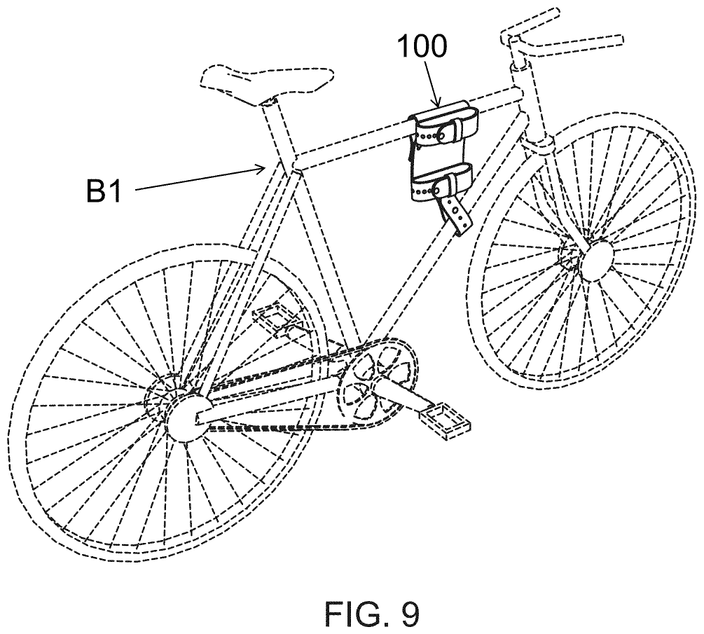

The bicycle U-lock holder 100 may be connected to a bicycle at different positions. For example, the bicycle U-lock holder 100 is shown connected to the rear of bicycle B1 in FIGS. 6 to 8. However, as shown in FIG. 9, the bicycle U-lock holder 100 may be connected to the front of the bicycle B1.

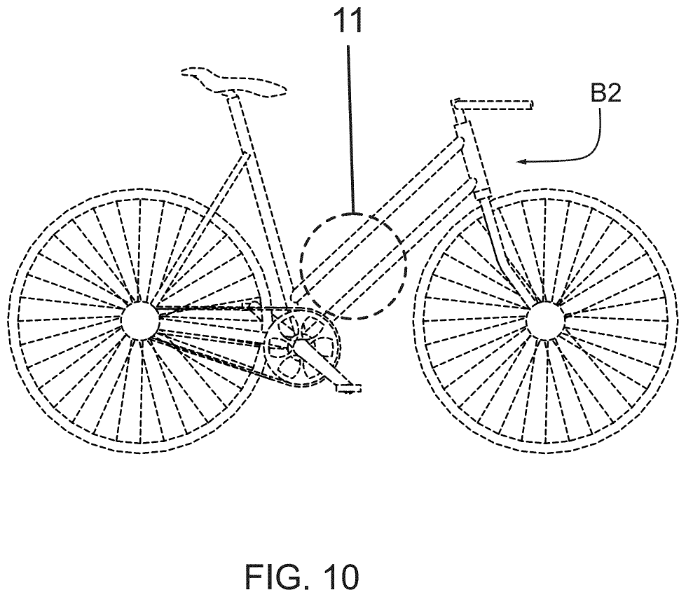

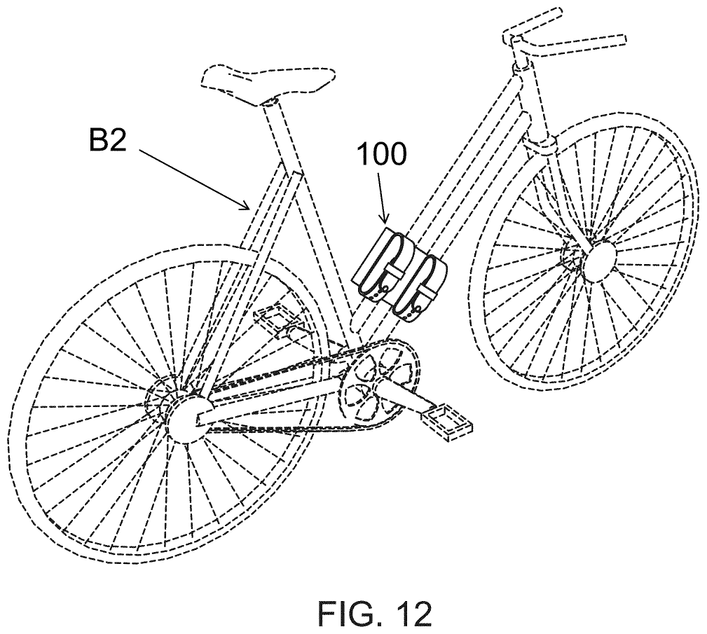

The bicycle U-lock holder 100 is adjustable to accommodate different sizes and shapes of bicycle frames. For example, the bicycle U-lock holder 100 may be connected to the bicycle B1 that is a diamond-framed bicycle (as shown in FIGS. 6 to 9). As another example, the bicycle U-lock holder 100 may be connected to a step-through bicycle B2 as shown in FIGS. 10 to 12 and may hold a U-lock such as U-lock U2.

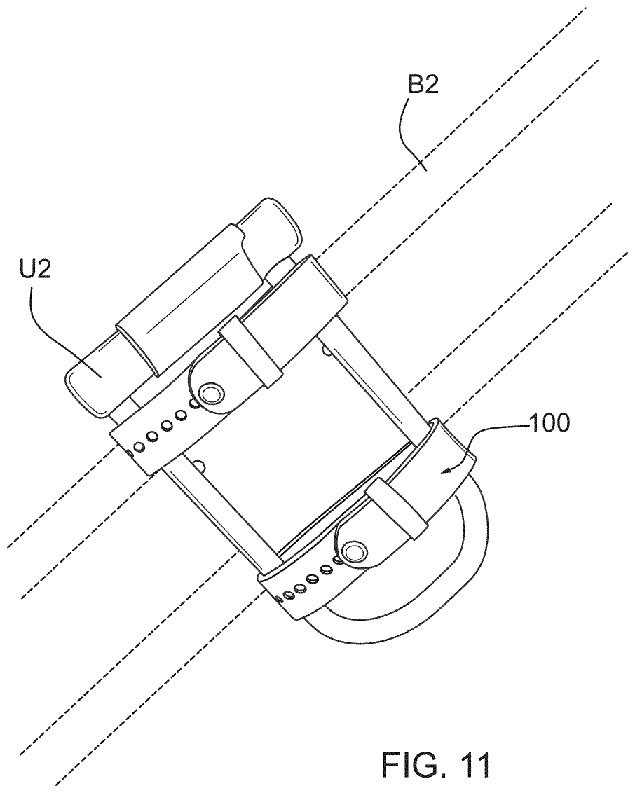

The bicycle U-lock holder 100 is adjustable to accommodate different sizes of U-locks. For example, the straps 230a, 230b of the bicycle U-lock holder 100 may be adjusted to accommodate a small-sized U-lock U1 shown in FIG. 7 or a larger-sized U-lock U2 shown in FIG. 11. It will be appreciated that the size of the U-lock that may be held by the bicycle U-lock holder 100 is not dependent on which type of bicycle the bicycle U-lock holder 100 is connected to. For example, the bicycle U-lock holder 100 may be connected to bicycle B2 and may hold U-lock U1. As another example, the bicycle U-lock holder 100 may be connected to bicycle B1 and may hold U-lock U2.

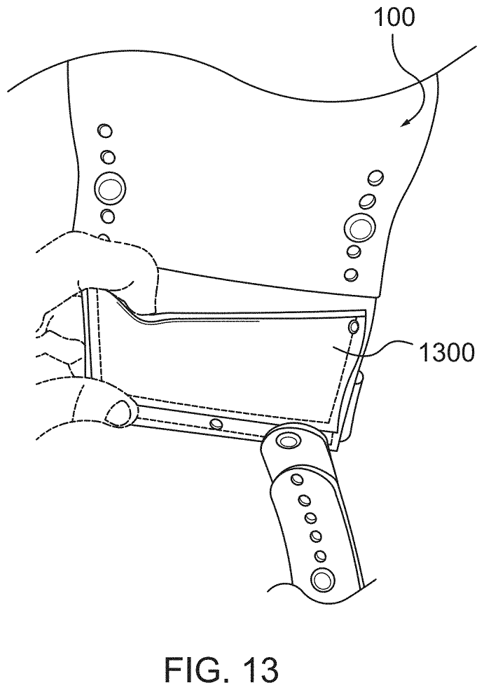

As shown in FIG. 13, a back side of the bicycle U-lock holder 100 may include a pocket 1300 and the pocket 1300 may be used to hold one or more items such as for example keys while the bicycle is in use.

Although in embodiments described herein the at least one strap is described as being connected to the main body, those skilled in the art will appreciate that variations are possible. For example, in another embodiment, the at least one strap may be integral with the main body and may extend therefrom. In this example, the at least one strap may include a first portion extending from a side of the main body and a second portion extending from an opposite side of the main body. The operation of the at least one strap in this embodiment is similar to that of the at least one strap 130 described herein and is similarly adjustable to accommodate different sizes of U-locks.

Although in embodiments described herein, one of the first portion and the third portion of each strap is described as including a single opening dimensioned to receive a connector and the other of the first portion and the third portion includes a plurality of openings dimensioned to receive the connector, those skilled in the art will appreciate that other variations are possible. For example, in another embodiment, one of the first portion and the third portion may include the connector, that is, a connector may be fixed on the first portion or the third portion. In this embodiment, the other of the first portion and the third portion includes a plurality of openings dimensioned to receive and retain the connector.

Although in embodiments described herein, the third plurality of openings defined in the main body is described as being aligned with openings on the strap, in another embodiment the third plurality of openings may be defined in the main body at a position adjacent to or below the strap. In this embodiment, the at least one removable strap may be connected to the main body by aligning one of the openings on the at least one removable strap with one of the third plurality of openings on the main body.

As noted, certain adaptations and modifications of the described embodiments can be made. Therefore, the above discussed embodiments are considered to be illustrative and not restrictive.

What is claimed is:

1. A bicycle U-lock holder comprising:
a main body, one end of the main body defining a foldable first portion that, when folded, defines a first loop dimensioned to circumscribe a first portion of a bicycle frame;
at least one strap extending from the main body, the at least one strap extending horizontally with respect to the main body and dimensioned to receive a U-lock; and
a removable strap having a first end connected to the main body and extending therefrom, the removable strap defining a second loop dimensioned to circumscribe a second portion of the bicycle frame.

2. The bicycle U-lock holder of claim 1, wherein the removable strap connects to one of a plurality of openings defined in an opposite end of the main body via a first connector, the plurality of openings dimensioned to receive the first connector.

3. The bicycle U-lock holder of claim 2, wherein the first connector includes a sex bolt.

4. The bicycle U-lock holder of claim 2, wherein the plurality of openings is three spaced-apart openings defined in the opposite end of the main body.

5. The bicycle U-lock holder of claim 2, wherein the removable strap includes a plurality of spaced apart openings dimensioned to receive the first connector or a second connector.

6. The bicycle U-lock holder of claim 5, wherein the second connector includes a sex bolt.

7. The bicycle U-lock holder of claim 4, wherein the first connector extends through one of the openings on the removable strap and one of the openings defined in the opposite end of the main body.

8. The bicycle U-lock holder of claim 5, wherein the second connector extends through one of the openings on the removable strap and another one of the openings on the removable strap thereby defining the second loop.

9. The bicycle U-lock holder of claim 1, wherein the at least one strap extending from the main body is adjustable to accommodate different sizes of the U-lock.

10. The bicycle U-lock holder of claim 8, wherein the at least one strap includes a first portion extending from a side of the main body, a second middle portion connected to the main body, and a third portion extending from an opposite side of the main body.

11. The bicycle U-lock holder of claim 10, wherein one of the first portion and the third portion includes a connector and the other of the first portion and the third portion includes a plurality of openings dimensioned to receive and retain the connector.

12. The bicycle U-lock holder of claim 11, wherein inserting the connector through a first one of the plurality of openings accommodates a first size of U-lock and inserting the connector through a second one of the plurality of openings accommodates a second size of U-lock.

13. The bicycle U-lock holder of claim 8, wherein the at least one strap extending from the main body is integral with the main body and includes a first portion extending from a side of the main body and a second portion extending from an opposite side of the main body.

14. The bicycle U-lock holder of claim 1, wherein the at least one strap extending from the main body includes a pair of spaced apart straps.

15. The bicycle U-lock holder of claim 1, wherein the foldable first portion includes a first plurality of openings dimensioned to receive a connector and main body includes a second plurality of openings dimensioned to receive the connector, the connector extending through one of the first plurality of openings and through one of the second plurality of openings thereby defining the first loop.

16. The bicycle U-lock holder of claim 15, wherein the connector includes a sex bolt.

17. The bicycle U-lock holder of claim 15, wherein inserting the connector through a first one of the first plurality of openings and through a first one of the second plurality of openings defines a first size of the first loop and inserting the connector through a second one of the first plurality of openings and through a second one of the second plurality of openings defines a second size of the first loop.

18. The bicycle U-lock holder of claim 1, wherein the main body is generally rectangular.

19. The bicycle U-lock holder of claim 1, wherein the main body is made of leather or rubber.

20. The bicycle U-lock holder of claim 1, wherein a back side of the main body includes a pocket.
